(19) United States
(12) Patent Application Publication
(10) Pub. No.: US 2025/0321575 A1
(43) Pub. Date: Oct. 16, 2025

(54) FINE-TUNING METHOD AND SYSTEM FOR ANOMALY TYPE CLASSIFICATION

(71) Applicant: FOUNDATION OF SOONGSIL UNIVERSITY-INDUSTRY COOPERATION, Seoul (KR)

(72) Inventors: Min Hae KWON, Seoul (KR); Mu Gon JOE, Seoul (KR); Mi Ru KIM, Seoul (KR)

(73) Assignee: FOUNDATION OF SOONGSIL UNIVERSITY-INDUSTRY COOPERATION, Seoul (KR)

(21) Appl. No.: 18/781,284

(22) Filed: Jul. 23, 2024

(30) Foreign Application Priority Data
Apr. 11, 2024 (KR) 10-2024-0048667

(51) Int. Cl. G05B 23/02

(52) U.S. Cl. CPC G05B 23/0275

(57) ABSTRACT

A fine-tuning method and system for classifying an anomaly type. The fine-tuning system for classifying an anomaly type comprises an anomaly detection device configured to collect abnormal data and normal data, and detect anomaly in the collected data through a hierarchical anomaly detection model with a plurality of pre-trained detection stages to output an entire latent vector for the collected data for each of the plurality of detection stages and a latent vector of data detected as anomaly; and an anomaly type classification device configured to perform pre-training and fine-tuning of the classification model for each of the plurality of detection stages using a set of the entire latent vectors and a set of latent vectors detected as anomaly, and classify an anomaly type of data detected as anomaly in each of the plurality of detection stages using the fine-tuned classification model.

### CROSS-REFERENCE TO RELATED APPLICATIONS

This application claims the benefit of Korean Patent Application 10-2024-0048667 filed on Apr. 11, 2024, in the Korean Intellectual Property Office. All disclosures of the document named above are incorporated herein by reference.

### TECHNICAL FIELD

The present invention relates to a fine-tuning method and system for classifying an anomaly type.

### BACKGROUND ART

With recent technological advancements and the increase in anomaly activities such as network intrusions, facility failures, and financial fraud, the importance of quick and appropriate response is emphasized. Since response plans are different depending on each intrusion method, an anomaly type should be accurately identified for effective response.

An anomaly type refers to the cause of an anomaly behavior or situation, and it appears in various forms.

Among the prior technologies for such anomaly type classification, the deep learning-based anomaly type classification method is a technology that performs anomaly type classification by inputting real-time collected data into a deep learning model that has trained the characteristics of pre-collected data. However, in the case of data used for training, there is an imbalance problem in which normal data that is easy to collect accounts for most of the data, so there is a problem that the model may be biased toward normal data.

Accordingly, research on classifying anomaly types by additionally utilizing a classification model in autoencoder-based anomaly detection technology is attracting attention. However, data related to anomaly types have an imbalance problem with anomaly data that is difficult to collect, and performance is limited due to the difference in distribution of anomaly types between the data detected from autoencoder-based anomaly detection and the training data of the classification model.

### DISCLOSURE

### Technical Issues

In order to solve the problems of the prior art described above, a fine-tuning method and system for anomaly type classification is disclosed that can prevent overall performance degradation due to the data imbalance problem and distribution differences between training data and detected data.

### Technical Solution

In order to achieve the above-described object, according to one embodiment of the present invention, a fine-tuning system for classifying an anomaly type comprises an anomaly detection device configured to collect abnormal data and normal data, and detect anomaly in the collected data through a hierarchical anomaly detection model with a plurality of pre-trained detection stages to output an entire latent vector for the collected data for each of the plurality of detection stages and a latent vector of data detected as anomaly; and an anomaly type classification device configured to perform pre-training and fine-tuning of the classification model for each of the plurality of detection stages using a set of the entire latent vectors and a set of latent vectors detected as anomaly, and classify an anomaly type of data detected as anomaly in each of the plurality of detection stages using the fine-tuned classification model.

The anomaly detection device may comprise a data collection unit for collecting the abnormal data and normal data; a hierarchical anomaly detection model training unit for training the hierarchical anomaly detection model using the normal data; and an anomaly detection performing unit for performing anomaly detection of input data using the pre-trained hierarchical anomaly detection model.

The hierarchical anomaly detection model training unit may be configured to learn the hierarchical anomaly detection model using the normal data and assign different anomaly scores to the collected data depending on whether it has similar characteristics to the normal data experienced in training, set a threshold for determining whether there is an anomaly in each of the plurality of detection stages, and output the entire latent vector for the collected data and the latent vector of data detected as anomaly using the threshold.

The anomaly type classification device may comprise a data storage unit for storing the set of entire latent vectors and the set of latent vectors of data detected as anomaly; a classification model training unit for pre-training a classification model for each of a plurality of detection stages using the set of the entire latent vectors; a classification model fine-tuning unit for fine-tuning a pre-trained classification model using a set of latent vectors of data detected as anomaly; and an anomaly type classification unit for classifying an anomaly type of data detected as anomaly among input data using the fine-tuned classification model.

The classification model for each of the plurality of pre-trained detection stages comprises a frozen parameters and a tunable parameter, wherein the frozen parameter is updated only in the pre-training, and the tunable parameter is updated in both the pre-training and the fine-tuning.

The classification model fine-tuning unit may select a set of latent vectors for a corresponding detection stage among data detected as anomaly in each detection stage.

The hierarchical anomaly detection model may be a hierarchical autoencoder model.

According to another embodiment of the present invention, an apparatus for classifying an anomaly type comprises a processor; and a memory connected to the processor and storing program instructions, wherein the program instructions, when executed by the processor, perform operations comprising, detecting anomaly in input data through a hierarchical anomaly detection model with a plurality of pre-trained detection stages using abnormal data and normal data collected in advance, and training using a set of latent vectors for the collected abnormal data and normal data output by the hierarchical anomaly detection model, and classifying an anomaly type of data detected as anomaly among the input data using a fine-tuned classification model for each of a plurality of detection stages using a set of latent vectors for the detected abnormal data.

According to another embodiment of the present invention, a method for performing fine-tuning for anomaly type classification comprises collecting abnormal data and normal data; detecting anomaly in the collected data through a hierarchical anomaly detection model having a plurality of pre-trained detection stages; outputting an entire latent vector for the collected data and a latent vector for data detected as anomaly for each of the plurality of detection stages; pre-training a classification model for each of the plurality of detection stages using the set of entire latent vectors and the set of latent vectors detected as anomaly; and fine-tuning the pre-trained classification model.

### DESCRIPTION OF DRAWINGS

These and/or other aspects will become apparent and more readily appreciated from the following description of the embodiments, taken in conjunction with the accompanying drawings in which:

FIG. 1 is a diagram showing the components of an anomaly type classification system using a hierarchical anomaly detection model and a classification model according to a preferred embodiment of the present invention;

FIG. 2 is a diagram illustrating an anomaly detection process using a hierarchical auto-encoder model according to the present embodiment;

FIG. 3 is a diagram illustrating an exemplary process of hierarchical anomaly detection using anomaly type classification and a latent vector set;

FIG. 4 is a diagram showing a flowchart of the overall training process according to an embodiment of the present invention;

FIG. 5 is a diagram showing a flowchart of the hierarchical autoencoder model training process according to the present embodiment;

FIG. 6 is a diagram illustrating a flowchart of the classification model pre-training process according to the present embodiment;

FIG. 7 is a diagram showing the configuration of an anomaly type classification system according to the present embodiment; and

FIG. 8 is a diagram showing a flowchart of the classification model fine-tuning process according to the present embodiment.

### DETAILED DESCRIPTION OF EMBODIMENTS

Since the present invention can make various changes and have various embodiments, specific embodiments will be illustrated in the drawings and described in the detailed description. However, this is not intended to limit the present invention to specific embodiments, and should be understood to include all changes, equivalents, and substitutes included in the spirit and technical scope of the present invention.

The terms used herein are only used to describe specific embodiments and are not intended to limit the invention. Singular expressions include plural expressions unless the context clearly dictates otherwise. In this specification, terms such as “comprise” or “have” are intended to designate the presence of features, numbers, steps, operations, components, parts, or combinations thereof described in the specification, but it should be understood that this does not exclude in advance the presence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope of maintaining the technical spirit of the present invention, and even if separate description is omitted, a plurality of embodiments may be re-implemented as a single integrated embodiment.

In addition, when describing with reference to the accompanying drawings, identical or related reference numerals will be given to identical or related elements regardless of the reference numerals, and overlapping descriptions thereof will be omitted. In describing the present invention, if it is determined that a detailed description of related known technologies may unnecessarily obscure the gist of the present invention, the detailed description will be omitted.

The present embodiment proposes a method to maximize performance by fine-tuning the classification model based on data detected during the training process of the classification model.

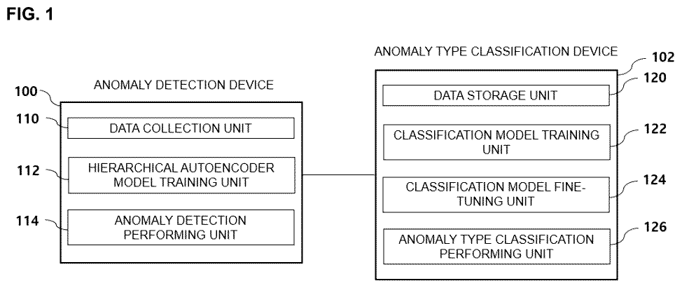

FIG. 1 is a diagram showing the components of an anomaly type classification system using a hierarchical anomaly detection model and a classification model according to a preferred embodiment of the present invention.

As shown in FIG. 1, the anomaly type classification system according to the present embodiment may comprise an anomaly detection device 100 and an anomaly type classification device 102.

The anomaly detection device 100 and the anomaly type classification device 102 utilize models trained in each device.

The anomaly detection device 100 performs anomaly detection hierarchically.

The anomaly detection device 100 according to the present embodiment can perform anomaly detection hierarchically by applying different thresholds to a plurality of detection stages through a hierarchical anomaly detection model.

The hierarchical anomaly detection model may be a hierarchical autoencoder model.

Hereinafter, the anomaly detection device 100 will be described as having a hierarchical anomaly detection model that is a hierarchical autoencoder model. However, this is for illustrative purposes only, and any neural network model that can perform anomaly detection hierarchically can be applied without limitation.

The anomaly detection device 100 according to the present embodiment may comprise a data collection unit 110, a hierarchical autoencoder model training unit 112, and an anomaly detection performing unit 114.

The data collection unit 110 pre-collects abnormal data and normal data.

The hierarchical autoencoder model training unit 112 learns a hierarchical autoencoder model using normal data among pre-collected data.

The anomaly detection unit 114 performs anomaly detection through a pre-trained hierarchical autoencoder model and provides the detected data to the anomaly type classification device 102.

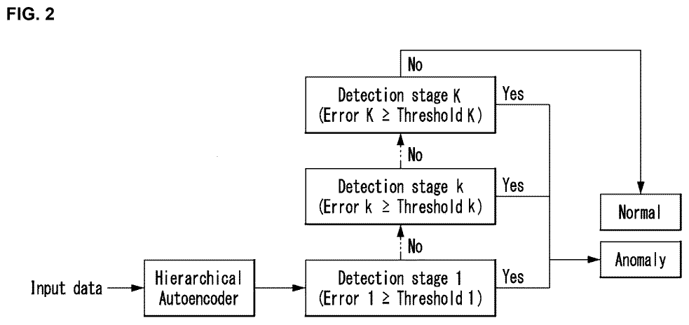

FIG. 2 is a diagram illustrating an anomaly detection process using a hierarchical autoencoder model according to the present embodiment.

FIG. 2 shows a process, in which the hierarchical autoencoder model comprises three detection stages (detection stages 1 to K), and each detection stage detects anomaly in input data through different thresholds (thresholds 1 to K).

As shown in FIG. 2, the anomaly detection unit 114 compares a plurality of input data with a threshold for each detection stage based on a hierarchical autoencoder model and outputs a latent vector for each input data.

For a plurality of input data, a set of latent vectors for entire input data (entire latent vector set) and a set of latent vectors for data detected as anomaly (anomaly latent vector set) are transmitted to the anomaly type classification device 102.

The anomaly type classification device 102 classifies the anomaly type of the detected data through a fine-tuned classification model.

The anomaly type classification device 102 may include a data storage unit 120, a classification model training unit 122, a classification model fine-tuning unit 124, and an anomaly type classification performing unit 126.

The data storage unit 120 stores the entire latent vector set and the anomaly latent vector set.

The classification model training unit 122 pre-trains a classification model using the entire latent vector set.

The classification model fine-tuning unit 124 fine-tunes the pre-trained classification model using a set of anomaly latent vectors.

The anomaly type classification performing unit 126 classifies the specific anomaly type of the detected data.

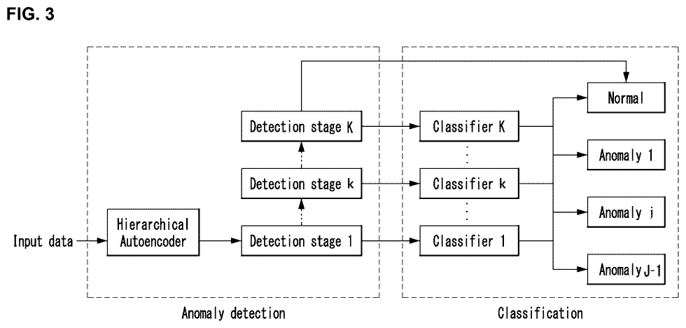

FIG. 3 is a diagram illustrating an exemplary process of hierarchical anomaly detection using anomaly type classification and a latent vector set.

Referring to FIG. 3, the anomaly type classification device 102 comprises classification models (classifiers 1 to K) for each detection stage, and each classification model classifies the anomaly type using a latent vector set output from each detection stage (the entire latent vector set and anomaly latent vector set) as input.

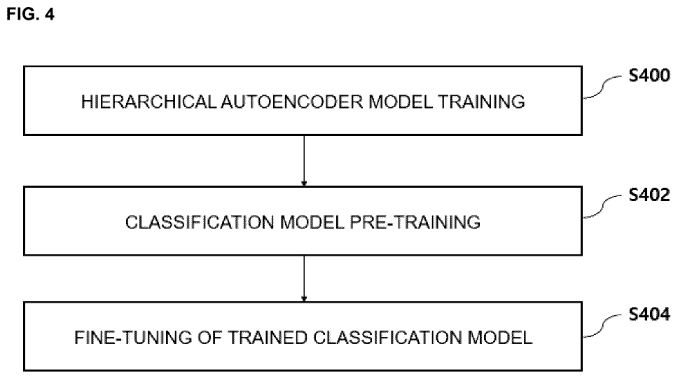

FIG. 4 is a diagram showing a flowchart of the overall training process according to an embodiment of the present invention.

Referring to FIG. 4, the anomaly type classification system sequentially performs hierarchical autoencoder model training (step 400), classification model pre-training (step 402), and fine-tuning of the trained classification model (step 404).

In step 400, anomaly detection using a hierarchical autoencoder model is a method of hierarchically detecting anomaly for each detection stage k(1≤k≤K) through a total of K detection stages.

Training of the hierarchical autoencoder model is carried out in the hierarchical autoencoder model training unit 112 using normal data among the pre-collected data of the data collection unit 110.

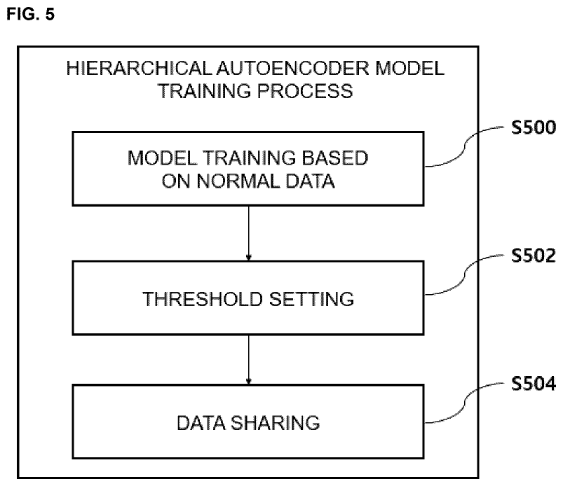

FIG. 5 is a diagram showing a flowchart of the hierarchical autoencoder model training process according to the present embodiment.

Referring to FIG. 5, first, the hierarchical autoencoder model training unit 112 performs model training based on normal data (step 500).

In step 500, a model is trained based on normal data among the pre-collected data set X, and a low anomaly score is given to data with similar characteristics to normal data experienced in training, and conversely, a high anomaly score is given to abnormal data with characteristics different from normal data.

Afterwards, a threshold setting process is performed (step 502).

In step 502, a threshold value that serves as a standard for anomaly in the kth detection stage is set.

The hierarchical autoencoder model outputs the entire latent vector set [symbol] ₖ for the entire data collected in the kth (1≤k≤K) detection stage for the pre-collected data set X, and the set [symbol] ₖ has the latent vector zₖ. The latent vector

$${𝒵}_{k}^{′} ⊆ {𝒵}_{k}$$

of data detected as anomaly in each detection stage is calculated through the anomaly score function ϵₖ(zₖ) and the threshold δₖ, and the calculation process is as follows.

$${𝒵}_{k}^{′} = \{ {z}_{k} \vert {ε}_{k} ( {z}_{k} ) \geq {δ}_{k} , {z}_{k} ∈ {𝒵}_{k} \} \qquad [ Equation 1 ]$$

The anomaly score function in Equation 1 calculates the anomaly score for the output [symbol] ₖ of the kth detection stage, and if the anomaly score is greater than or equal to the threshold, it is determined as abnormal data.

Afterwards, a data sharing process is performed (step 504).

In step 504, for the pre-collected data set X, the label Y˜Q, which follows the distribution for the latent vector sets [symbol] ₖ and Q of the kth detection stage, and the label

$${Y}_{k}^{′} \sim {Q}_{k}^{′} ,$$

which follows the distribution for the anomaly latent vector sets

$${𝒵}_{k}^{′} ⊆ {𝒵}_{k} and {Q}_{k}^{′} ,$$

are shared in the data storage unit 120.

The classification model training unit 122 performs pre-training of the classification model using the latent vector set [symbol] ₖ of each detection stage stored in the data storage unit 120.

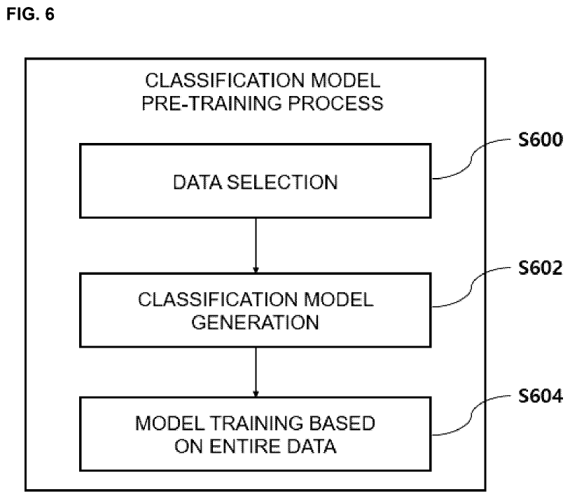

FIG. 6 is a diagram illustrating a flowchart of the classification model pre-training process according to this embodiment.

Referring to FIG. 6, the classification model training unit 122 performs a data selection process (step 600).

In step 600, the entire latent vector set [symbol] ₖ among the data shared in the data storage unit 120 is selected in order to learn the overall characteristics of the data.

After data selection, a classification model {ψₖ, ϕₖ} for each detection stage is generated (step 602).

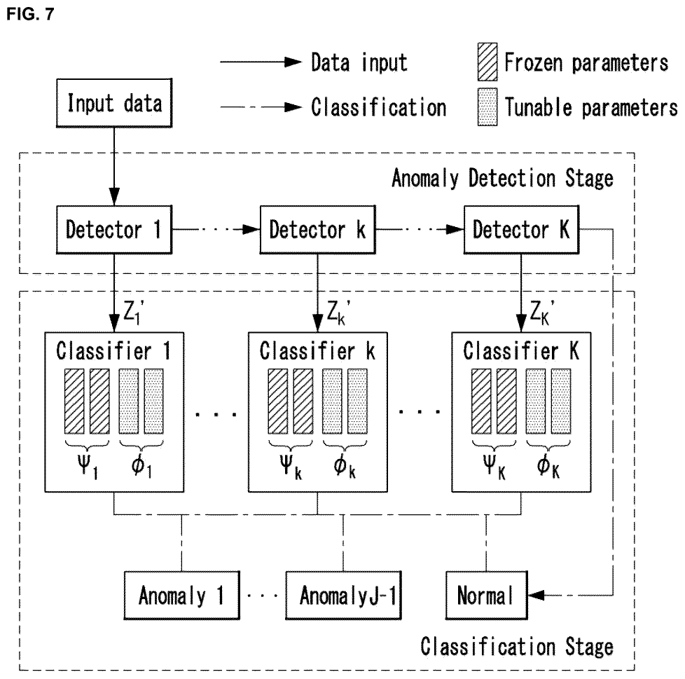

FIG. 7 is a diagram showing the configuration of an anomaly type classification system according to the present embodiment.

As shown in FIG. 7, in step 602, frozen parameters ψₖ and tunable parameters ϕₖ of the classification model {ψₖ, ϕₖ} of each detection stage are selected.

Here, frozen parameters are updated only in pre-training, and tunable parameters are updated in both pre-training and fine-tuning.

Afterwards, the entire data-based model training process is performed (step 604).

In step 604, a classification model {ψₖ, ϕₖ} is trained using the entire latent vector set [symbol] ₖ and the corresponding label Y. The objective function for the latent vector [symbol] ₖ, which is the input data of the classification model, and the corresponding label Y is as follows.

$$\{ {ψ}_{k}^{+} , {ϕ}_{k}^{+} \} = {argmin}_{\{ {ψ}_{k} , {ϕ}_{k} \}} {𝔼}_{y \sim Q} ℒ ( {𝒵}_{k} , 𝒴 ; \{ {ψ}_{k} , {ϕ}_{k} \} ) \qquad [ Equation 2 ]$$

In Equation 2, the cross entropy loss function [symbol] ( [symbol] ₖ, [symbol] ; {ψₖ, ϕₖ}) represents the difference between the predicted probability value for the input data [symbol] ₖ and the actual value for the anomaly type [symbol] when input data ∞ₖ and anomaly type [symbol] are input into the classification model {ψₖ, ϕₖ}.

Equation 2 aims to obtain a pre-training model

$$\{ {ψ}_{k}^{+} , {ϕ}_{k}^{+} \}$$

that minimizes the loss function using the latent vector sets [symbol] ₖ and Y˜Q.

This means that the purpose of the classification model {ψₖ, ϕₖ} for each detection stage is to learn the overall characteristics of the entire data.

Through the process shown in FIG. 6, the classification model for each detection stage learns the overall characteristics of the data.

The classification model fine-tuning unit 124 performs fine-tuning of the classification model using data

$${Z}_{k}^{′}$$

detected as anomaly stored in the data storage unit 120 after pre-training the classification model.

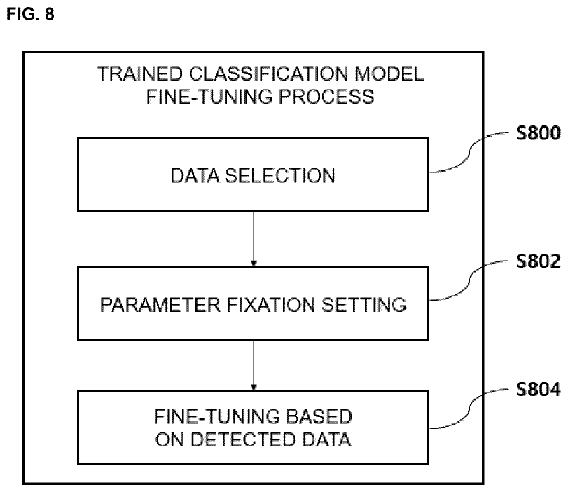

FIG. 8 is a diagram showing a flowchart of the classification model fine-tuning process according to this embodiment.

Referring to FIG. 8, the classification model fine-tuning unit 124 optimizes the parameters of the pre-trained model according to the distribution of the detected data, that is, selects a set of anomaly latent vectors

$${Z}_{k}^{′}$$

from the data stored in the data storage unit 120 depending on the purpose of detection (step 800).

In step 800, the classification model fine-tuning unit 124 may select a latent vector set for the corresponding detection stage among data detected as anomaly in each detection stage.

Next, the classification model fine-tuning unit 124 performs a parameter fixation setting process (step 802).

In step 802, a frozen parameter

$${ψ}_{k}^{+}$$

is fixation set in the pre-trained classification model

$$\{ {ψ}_{k}^{+} , {ϕ}_{k}^{+} \}$$

so that it is not updated.

Since the distribution of data

$${Q}_{k}^{′}$$

detected in each detection stage is different from the distribution Q of pre-trained data, the classification model fine-tuning unit 124 performs a fine-tuning process based on the detected data (step 804).

In step 704, a fine-tuning process is performed to optimize the pre-trained anomaly type classification model

$$\{ {ψ}_{k}^{+} , {ϕ}_{k}^{+} \}$$

to the distribution

$${Q}_{k}^{′}$$

for high-performance anomaly type classification.

The objective function of the fine-tuning process of the pre-trained model

$$\{ {ψ}_{k}^{+} , {ϕ}_{k}^{+} \}$$

is as follows.

$${ϕ}_{k}^{*} = {argmin}_{{ϕ}_{k}} {E}_{{Y}_{k}^{′} \sim {Q}_{k}^{′}} \cdot L ( {Z}_{k}^{′} , {Y}_{k}^{′} ; \{ {ψ}_{k}^{+} , {ϕ}_{k}^{+} \} ) \qquad [ Equation 3 ]$$

The purpose of Equation 3 is to obtain a tunable parameter

$${ϕ}_{k}^{*}$$

to minimize the loss function L using a set of anomaly latent vectors

$${Z}_{k}^{′}$$

and their corresponding labels

$${Y}_{k}^{′} \sim {Q}_{k}^{′}$$

According to this embodiment, the above-described hierarchical autoencoder model training, classification model pre-training, and trained classification model fine-tuning are repeatedly performed.

After training is completed, anomaly type classification comprises a hierarchical autoencoder-based anomaly detection process and an anomaly type classification process of the detected data, as shown in FIG. 3.

The hierarchical autoencoder-based anomaly detection process is performed in the anomaly detection performing unit 114 of the anomaly detection device 100.

Data subject to classification is input into a hierarchical autoencoder comprising a total of K detection stages, and abnormal data is detected through an anomaly score function ϵₖ( [symbol] ₖ) and threshold δₖ for each detection stage.

Afterwards, the detected data is transmitted to the anomaly type classification device 102.

The anomaly type classification performing unit 126 inputs the detected data into a classification model for each detection stage and classifies the anomaly type of the data.

The anomaly type classification system of the present invention shows better performance than the conventional anomaly type classification technology.

To confirm this performance, an experiment was conducted to compare the performance of the anomaly type classification system of the present invention with the prior art, and the results are presented in Table 1. The experiment was conducted on the commonly used imbalanced network datasets NSL-KDD and CSE-CIC-IDS 2018, which include data containing anomaly types. Table 1 confirms that the performance of the anomaly type classification system through the present invention is about 8% higher than that of the prior art. Therefore, it was proven that problems caused by data imbalance and differences in distribution of training data were effectively solved using the fine-tuning.

TABLE 1

| | | Autoencoder-based | |
|---|---|---|---|
| | Proposed Accuracy | accuracy | DNN accuracy |
| NSL-KDD | 0.9036(±0.0161) | 0.8338(±0.0044) | 0.8595(±0.0053) |
| IDS 2018 | 0.9500(±0.0032) | 0.8547(±0.0045) | 0.8272(±0.0024) |

The fine-tuning method for classifying anomaly types described above can also be implemented in the form of a recording medium containing instructions executable by a computer, such as an application or program module executed by a computer. Computer-readable media can be any available media that can be accessed by a computer and includes both volatile and non-volatile media, removable and non-removable media. Additionally, computer-readable media may include computer storage media. Computer storage media includes both volatile and non-volatile, removable and non-removable media implemented in any method or technology for storage of information such as computer-readable instructions, data structures, program modules, or other data.

The above-described embodiments of the present invention have been disclosed for illustrative purposes, and those skilled in the art will be able to make various modifications, changes, and additions within the spirit and scope of the present invention, and such modifications, changes, and additions should be regarded as falling within the scope of the patent claims below.

1. A fine-tuning system for classifying an anomaly type comprising:
an anomaly detection device configured to collect abnormal data and normal data, and detect anomaly in the collected data through a hierarchical anomaly detection model with a plurality of pre-trained detection stages to output an entire latent vector for the collected data for each of the plurality of detection stages and a latent vector of data detected as anomaly; and
an anomaly type classification device configured to perform pre-training and fine-tuning of the classification model for each of the plurality of detection stages using a set of the entire latent vectors and a set of the latent vectors detected as anomaly, and classify an anomaly type of data detected as anomaly in each of the plurality of detection stages using the fine-tuned classification model.

2. The system of claim 1, wherein the anomaly detection device comprises,
a data collection unit for collecting the abnormal data and normal data;
a hierarchical anomaly detection model training unit for training the hierarchical anomaly detection model using the normal data; and
an anomaly detection performing unit for performing anomaly detection of input data using the pre-trained hierarchical anomaly detection model.

3. The system of claim 2, wherein the hierarchical anomaly detection model training unit is configured to,
learn the hierarchical anomaly detection model using the normal data and assign different anomaly scores to the collected data depending on whether it has similar characteristics to the normal data experienced in training,
set a threshold for determining whether there is an anomaly in each of the plurality of detection stages, and
output the entire latent vector for the collected data and the latent vector of data detected as anomaly using the threshold.

4. The system of claim 1, wherein the anomaly type classification device comprises,
a data storage unit for storing the set of entire latent vectors and the set of latent vectors of data detected as anomaly;
a classification model training unit for pre-training a classification model for each of a plurality of detection stages using the set of the entire latent vectors;
a classification model fine-tuning unit for fine-tuning a pre-trained classification model using a set of latent vectors of data detected as anomaly; and
an anomaly type classification unit for classifying an anomaly type of data detected as anomaly among input data using the fine-tuned classification model.

5. The system of claim 4, wherein the classification model for each of the plurality of pre-trained detection stages comprises a frozen parameters and a tunable parameter,
wherein the frozen parameter is updated only in the pre-training, and the tunable parameter is updated in both the pre-training and the fine-tuning.

6. The system of claim 5, wherein the classification model fine-tuning unit selects a set of latent vectors for a corresponding detection stage among data detected as anomaly in each detection stage.

7. The system of claim 1, wherein the hierarchical anomaly detection model is a hierarchical autoencoder model.

8. An apparatus for classifying an anomaly type comprising:
a processor; and
a memory connected to the processor and storing program instructions,
wherein the program instructions, when executed by the processor, perform operations comprising,
detecting anomaly in input data through a hierarchical anomaly detection model with a plurality of pre-trained detection stages using abnormal data and normal data collected in advance, and
training using a set of latent vectors for the collected abnormal data and normal data output by the hierarchical anomaly detection model, and classifying an anomaly type of data detected as anomaly among the input data using a fine-tuned classification model for each of a plurality of detection stages using a set of latent vectors for the detected abnormal data.

9. The apparatus of claim 8, wherein the hierarchical anomaly detection model outputs an entire latent vector for the input data and a latent vector for data detected as anomaly using thresholds differently set for each of the plurality of detection stages.

10. The apparatus of claim 9, wherein the fine-tuned classification model for each of the plurality of detection stages classifies an anomaly type of data detected as anomaly output from each of the plurality of detection stages.

11. A method for performing fine-tuning for anomaly type classification comprises,
collecting abnormal data and normal data;
detecting anomaly in the collected data through a hierarchical anomaly detection model having a plurality of pre-trained detection stages;
outputting an entire latent vector for the collected data and a latent vector for data detected as anomaly for each of the plurality of detection stages;
pre-training a classification model for each of the plurality of detection stages using the set of entire latent vectors and the set of latent vectors detected as anomaly; and
fine-tuning the pre-trained classification model.

12. The method of claim 11 further comprises,
prior to the detecting the anomaly,
training the hierarchical anomaly detection model using the normal data and assigning different anomaly scores to the collected data depending on whether it has similar characteristics to the normal data experienced in training; and
setting a threshold for determining whether there is an anomaly in each of the plurality of detection stages.

13. The method of claim 12 further comprises,
prior to the pre-training,
storing the set of entire latent vectors and the set of latent vectors of the data detected as anomaly,
wherein the pre-training comprises pre-training a classification model for each of a plurality of detection stages using the set of entire latent vectors.

14. The method of claim 13, wherein the fine-tuning comprises,
fine-tuning a pre-trained classification model using the set of latent vectors of data detected as anomaly.

15. The method of claim 14, wherein the classification model for each of the plurality of pre-trained detection stages comprises a frozen parameters and a tunable parameter,
wherein the frozen parameter is updated only in the pre-training, and the tunable parameter is updated in both the pre-training and the fine-tuning.

16. The method of claim 15, wherein the fine-tuning comprises,
selecting a set of latent vectors for a corresponding detection stage among data detected as anomaly in each detection stage.
